(19) United States
(12) Patent Application Publication
(10) Pub. No.: US 2024/0333861 A1
(43) Pub. Date: Oct. 3, 2024

(54) IMAGE PROCESSING APPARATUS, IMAGE FORMING APPARATUS, IMAGE PROCESSING METHOD, AND RECORDING MEDIUM

(71) Applicant: Yuya ITOH, Kanagawa (JP)

(72) Inventor: Yuya ITOH, Kanagawa (JP)

(73) Assignee: Ricoh Company, Ltd., Tokyo (JP)

(21) Appl. No.: 18/623,305

(22) Filed: Apr. 1, 2024

(30) Foreign Application Priority Data
Apr. 3, 2023 (JP) 2023-060425

(51) Int. Cl. H04N 1/60; G06T 7/194; G06V 10/54; G06V 10/56; G06V 10/764

(52) U.S. Cl. CPC H04N 1/60; G06T 7/194; G06V 10/54; G06V 10/56; G06V 10/764; G06T 2207/10024

(57) ABSTRACT

An image processing apparatus includes circuitry configured to classify multiple regions in an input image into a foreground region containing a foreground image and a background region containing a background image; extract a brightness component and a color component of each of the multiple regions; determine whether, among the multiple regions, an attention region and each of multiple reference regions around the attention region are similar based on a difference between color components of the attention region and a corresponding one of the reference regions; correct, in response to the attention region being determined to be included in the background region, the attention region using a reference region determined to be similar to the attention region; and generate a show-through removed image, from which a show-through component of the input image is removed, by sequentially shifting the attention region to a subsequent attention region to correct the shifted attention region.

### CROSS-REFERENCE TO RELATED APPLICATION

The present application is based on and claims priority under 35 U.S.C. § 119 to Japanese Patent Application No. 2023-060425, filed on Apr. 3, 2023, the content of which is incorporated herein by reference in its entirety.

### BACKGROUND OF THE INVENTION

### 1. Field of the Invention

The present disclosure relates to an image processing apparatus, an image forming apparatus, an image processing method, and a non-transitory computer-readable recording medium storing an image processing program.

### 2. Description of the Related Art

When the surface of a sheet containing images, characters, and the like on both surfaces is read by a scanner, so-called show-through may occur where images, characters, and the like on the back surface are included in image data of the surface acquired by scanning. Therefore, various correction methods have been proposed to remove show-through from image data of a surface containing show-through.

For example, the show-through component is removed by detecting an edge included in image data acquired by a scanner, estimating a background color from a portion where the intensity of the edge is low, and replacing the portion where the intensity of the edge is low, which indicates a show-through component, with the background color. Further, a show-through component may be reduced by calculating a representative color (background color) from a region where a difference in pixel value including brightness (luminance) and saturation between an attention region and a reference region in image data acquired by a scanner that is equal to or less than a threshold, and replacing the attention region with the representative color (see, for example, Patent Document 2).

### RELATED ART DOCUMENTS

### Patent Documents

[Patent Document 1] Japanese Unexamined Patent Application Publication No. 2001-169080
[Patent Document 2] Japanese Unexamined Patent Application Publication No. 2003-283831

### SUMMARY OF THE INVENTION

According to at least one aspect of the present disclosure, an image processing apparatus is provided. The image processing apparatus includes circuitry configured to
classify a plurality of regions in an input image into a foreground region containing a foreground image and a background region containing a background image;
extract a brightness component and a color component of each of the plurality of regions;
determine whether, from among the plurality of regions, an attention region and each of a plurality of reference regions located around the attention region are similar based on a difference between a color component of the attention region and a color component of a corresponding one of the plurality of reference regions;
correct, in response to the attention region being determined to be included in the background region, the attention region using a reference region determined to be similar to the attention region; and
generate a show-through removed image, from which a show-through component of the input image is removed, by sequentially shifting the attention region to a subsequent attention region to correct the shifted attention region.

### BRIEF DESCRIPTION OF THE DRAWINGS

FIG. 1 is an overall configuration view illustrating an example of an image forming apparatus including an image processing apparatus according to a first embodiment of the present disclosure.

FIG. 2 is a perspective sectional view illustrating an example of an image reader in FIG. 1.

FIG. 3 is a block diagram illustrating an example of a functional configuration of the image processing apparatus in FIG. 1.

FIG. 4 is a block diagram illustrating an example of a hardware configuration of the image processing apparatus in FIG. 1.

FIG. 5 is an explanatory diagram illustrating a state in which show-through occurs in an image reader in FIG. 2.

FIG. 6 is a functional block diagram illustrating an outline of a show-through correction process performed by the image processing apparatus in FIG. 3.

FIG. 7 is a diagram illustrating an example of an attention region and reference regions used in the show-through correction process in FIG. 6.

FIG. 8 is a flowchart illustrating an example of a show-through correction process by a show-through corrector in FIG. 6.

FIG. 9 is a functional block diagram illustrating an outline of a show-through correction process performed by an image processing apparatus according to a second embodiment of the present disclosure.

FIG. 10 is a diagram illustrating an example of an identical background determination result by an identical background determiner in FIG. 9.

FIG. 11 is a flowchart illustrating an example of a show-through correction process by a show-through corrector in FIG. 9.

FIG. 12 is a functional block diagram illustrating an outline of a show-through correction process performed by an image processing apparatus according to a third embodiment of the present disclosure.

FIG. 13 is a flowchart illustrating an example of a show-through correction process by a show-through corrector in FIG. 12.

FIG. 14 is a functional block diagram illustrating an outline of a show-through correction process performed by an image processing apparatus according to a fourth embodiment of the present disclosure.

FIG. 15 is a flowchart illustrating an example of a show-through correction process by a show-through corrector in FIG. 14.

FIG. 16 is a flowchart illustrating an example of a representative color calculation process in the show-through correction process executed by an image processing apparatus according to a fifth embodiment of the present disclosure.

### DETAILED DESCRIPTION OF THE INVENTION

In general, the show-through and the background are different in brightness but similar in saturation in many cases. Therefore, when the show-through is corrected based on the difference in pixel values including brightness such as RGB or the like, regions without show-through would not be corrected, resulting in an abnormal image, or regions with show-through would not be corrected.

Thus, it is desirable to provide a technique for performing a correction process on a region with show-through while preventing generation of an abnormal image that occurs when the show-through correction process is performed on a region without show-through.

According to the present disclosure, it is possible to provide a technique to perform a correction process on a region with show-through while preventing an abnormal image from being generated by performing the correction process on a region without show-through.

Hereinafter, embodiments will be described with reference to the accompanying drawings. In the drawings, the same components are denoted by the same reference numerals, and a duplicate description thereof may be omitted.

### First Embodiment

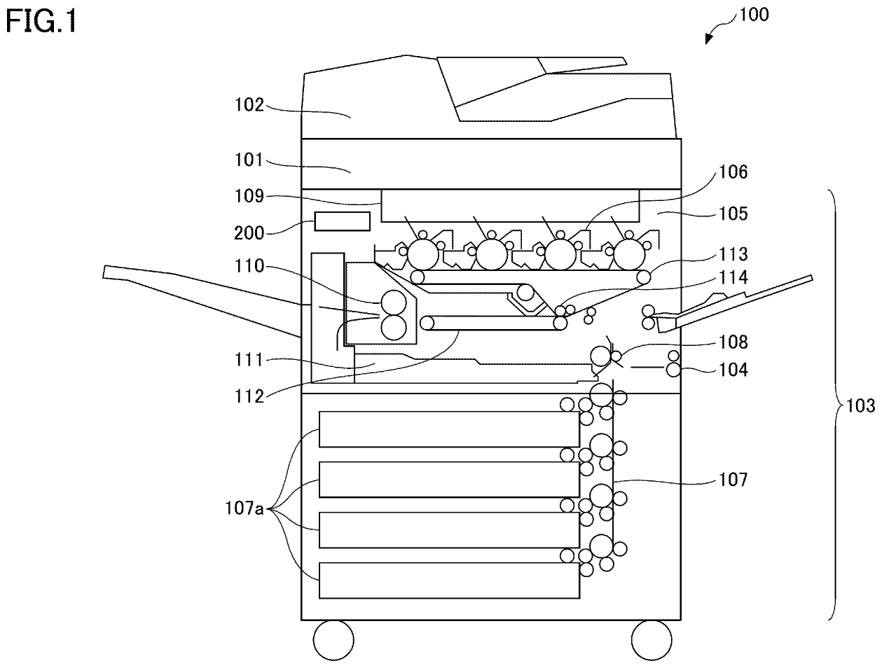

FIG. 1 is an overall configuration view illustrating an example of an image forming apparatus including an image processing apparatus according to a first embodiment of the present disclosure. An image forming apparatus 100 illustrated in FIG. 1 is, for example, a digital multi-functional printer (MFP) having a copying function, a printing function, a scanner function, a facsimile function, and the like.

The image forming apparatus 100 is capable of switching operation modes for implementing a copying function, a printing function, a scanner function, a facsimile function, and the like by an application switching key or the like of an operation unit (not illustrated). The image forming apparatus 100 is in a copy mode when the copying function is selected, is in a print mode when the printing function is selected, is in a scanner mode when the scanner function is selected, and is in a facsimile mode when the facsimile function is selected.

In addition, the internal state of the image forming apparatus 100 is switched to a normal mode, an energy saving mode (power saving mode), or the like according to a state of an internal circuit. For example, the normal mode includes an operating mode (operating state) and a standby mode (standby state).

For example, the operating mode includes a copy mode or a print mode in which an image, text data, or the like is printed on a paper medium or the like. The print mode includes an operation of printing received data on a paper medium or the like in the facsimile mode. The operating mode includes a transmission/reception operation in a scanner mode or a facsimile mode for scanning a document or the like. The state of the internal circuit is switched by a user's operation of an operation unit of the image forming apparatus 100 or control in the image forming apparatus 100.

The image forming apparatus 100 includes an image reader 101, an automatic document feeder (ADF) 102, and an image forming unit 103. In FIG. 1, the image forming unit 103 is illustrated in a state where the inside of the image forming apparatus is seen through for facilitating understanding of the description. The image forming unit 103 includes a manual feed roller 104, imaging units 105, image forming elements 106, a recording sheet feeder 107, and a plurality of recording sheet feeding cassettes 107a. The image forming unit 103 includes a registration roller 108, an optical writing device 109, a fixing device 110, a reversing mechanism 111, a secondary transfer belt 112, an intermediate transfer belt 113, a transfer unit 114, and an image processing apparatus 200. The image processing apparatus 200 may be located outside of the image forming unit 103 in the image forming apparatus 100.

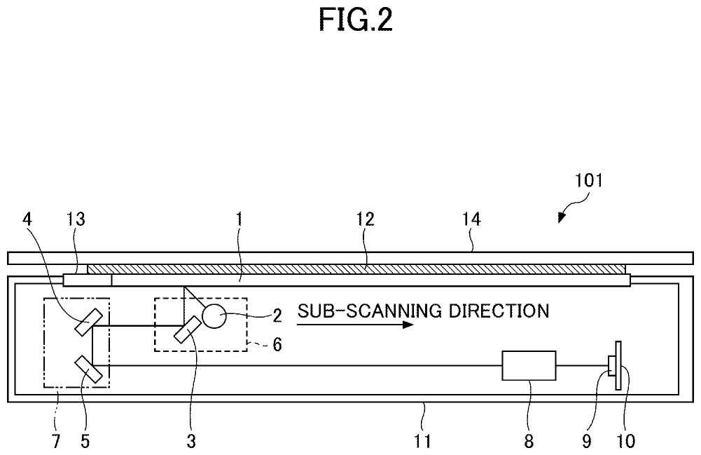

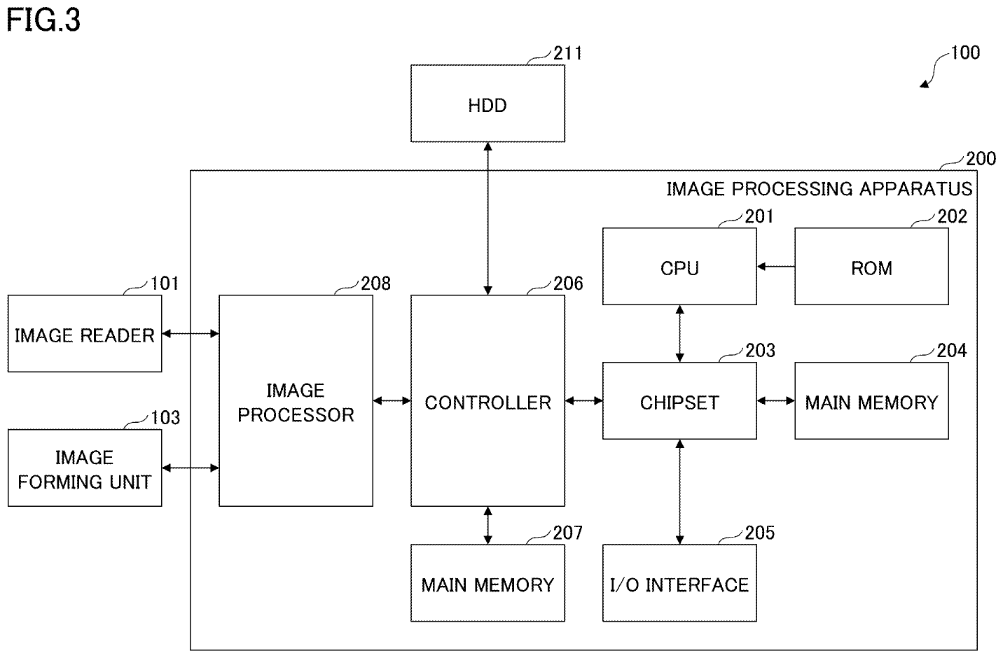

The ADF 102 automatically conveys a document placed on a placement table to an image reading position. The image reader 101 is, for example, a scanner having an image sensor, and reads an image of a document conveyed to a reading position by the ADF 102. An example of the image reader 101 is illustrated in FIG. 2. The image processing apparatus 200 performs processing on image data of a document read by the image reader 101. An example of the image processing apparatus 200 is illustrated in FIG. 3.

The image forming unit 103 has a function of printing an image on a recording sheet by an electrophotographic system based on image data of a document read by the image reader 101 and processed by the image processing apparatus 200. The image forming unit 103 is not limited to the electrophotographic system, and may employ an inkjet system to print an image on a recording sheet.

The manual feed roller 104 has a function of feeding a recording sheet set by a user into the image forming unit 103. The recording sheet feeder 107 has a function of feeding a recording sheet from any of a plurality of recording sheet feeding cassettes 107a in which a recording sheet is set. The registration roller 108 conveys the recording sheet fed from the manual feed roller 104 or the recording sheet feeder 107 to the secondary transfer belt 112.

The optical writing device 109 converts image data read by the image reader 101 and processed by the image processing apparatus 200 into optical information. The imaging units (Y, M, C, and K) 105 include four photosensitive drums (Y, M, C, and K), and image forming elements 106 including charging rollers, developing devices, primary transfer rollers, cleaner units, static eliminators, and the like provided around the respective photosensitive drums. Here, the reference symbol Y denotes yellow, the reference symbol M denotes magenta, the reference symbol C denotes cyan, and the reference symbol K denotes black.

The image forming elements 106 form toner images corresponding to visual information of the respective colors converted by the optical writing device 109 on the respective photosensitive drums. The toner image formed on each photosensitive drum is transferred onto the intermediate transfer belt 113 by the primary transfer roller. The full-color toner image transferred onto the intermediate transfer belt 113 moves to the transfer unit 114 along with the traveling of the intermediate transfer belt 113, and is transferred onto the recording sheet positioned on the secondary transfer belt 112 in the transfer unit 114.

The recording sheet on which the toner images are transferred is conveyed to the fixing device 110 along with the traveling of the secondary transfer belt 112. The fixing device 110 fixes the toner images on the recording sheet. The recording sheet on which the toner images are fixed is discharged from a discharge unit, and the printing processing of the color image on the recording sheet is completed.

In double-sided printing for printing images on both sides of the recording sheet, the recording sheet is reversed by the reversing mechanism 111, and the reversed recording sheet is sent onto the secondary transfer belt 112.

FIG. 2 is a perspective sectional view illustrating an example of the image reader 101 in FIG. 1. The image reader 101 includes a main body 11, a contact glass 1 disposed on the main body 11, a reference white plate 13 having a white color serving as a reference, and a background plate 14 that interposes a document 12 between the background plate 14 and the contact glass 1. The main body 11 includes a first carriage 6 including a light source 2 and a mirror 3, a second carriage 7 including mirrors 4 and 5, a lens unit 8, and a sensor substrate 10 on which an image sensor 9 is mounted.

For example, the light source 2 is a light emitting diode (LED). The image sensor 9 is a line sensor such as a CCD (Charge Coupled Device) image sensor or a CMOS (Complementary Metal Oxide Semiconductor) image sensor. The image sensor 9 includes a plurality of pixels arranged along a main scanning direction (a depth direction in FIG. 2 that is a direction orthogonal to a sub-scanning direction).

In an image reading operation, the image reader 101 irradiates the document 12 placed on the contact glass 1 and covered by the background plate 14 with light from the light source 2. The image reader 101 moves the first carriage 6 and the second carriage 7 from a standby position (home position) in the sub-scanning direction while the document 12 is irradiated with light. The first carriage 6 and the second carriage 7 that move in the sub-scanning direction sequentially guide the reflected light from a region of the document 12 facing the mirror 3 to the lens unit 8. The lens unit 8 forms an image on the image sensor 9 with the reflected light sequentially received via the first carriage 6 and the second carriage 7. The image sensor 9 photoelectrically converts the reflected light image of the document 12 formed via the lens unit 8, and outputs the converted image as read image data.

Further, for example, when the power is turned on, the image reader 101 moves the first carriage 6 to a position facing the reference white plate 13 and turns on the light source 2. The image reader 101 forms an image of the reflected light received from the reference white plate 13 on the image sensor 9, acquires white distribution data in the main scanning direction, and performs gain adjustment to set reference data. The reference data is stored in a memory (not illustrated) and used for shading correction for correcting color unevenness or the like of the read image.

FIG. 3 is a block diagram illustrating an example of a functional configuration of the image processing apparatus 200 in FIG. 1. For example, the image processing apparatus 200 performs image processing on a document image read by the image reader 101.

The image processing apparatus 200 includes a central processing unit (CPU) 201, a read only memory (ROM) 202, a chipset 203, a main memory 204, an input/output (I/O) interface 205, a controller 206, a main memory 207, and an image processor 208. For example, the I/O interface 205, the controller 206, and the image processor 208 are designed by hardware configurable circuitry such as an application specific integrated circuit (ASIC) or a field-programmable gate array (FPGA) circuitry.

The CPU 201 controls an overall operation of the image processing apparatus 200. The CPU 201 is an example of a computer. The CPU 201 may control the entire operation of the image forming apparatus 100 in FIG. 1. The CPU 201 executes various image processing by executing an image processing program. The ROM 202 holds a boot loader and the like executed by the CPU 201 at the time of power-on or reset of the image forming apparatus 100 in FIG. 1.

The chipset 203 is connected to the CPU 201, the main memory 204, the I/O interface 205, and the controller 206, and controls data transmission between the CPU 201, the main memory 204, the I/O interface 205, and the controller 206.

The main memory 204 stores an image processing program executed by the CPU 201, a work-data used by the CPU 201, an image-data processed by the CPU 201, and the like. For example, the image processing program may be loaded from a hard disk drive (HDD) 211 connected to the image processing apparatus 200 to the main memory 204. The HDD 211 may be used for temporarily storing the processed image data.

The I/O interface 205 is a network interface, a peripheral component interconnect (PCI), a serial interface, or an interface for various memory cards, which are not illustrated. The image processing apparatus 200 can implement optional additional functions such as an image processing function, an accelerator function, and an encryption processing function by a device connected to the I/O interface 205.

The controller 206 inputs and outputs image data to and from the image processor 208, the main memories 207 and 204, or the HDD 211. For example, the controller 206 executes a rotation process or an editing process on the image transferred from the image processor 208 or the main memory 204, and outputs the processed image to the HDD 211, the image processor 208, the main memory 207, or the like. The main memory 207 may be used as an image memory when the controller 206 performs image processing.

The image processor 208 performs image processing on the image data generated by the image reader 101 and outputs the processed image data to the controller 206. The image processor 208 performs image processing on image data transferred from the controller 206 and outputs the processed image data to the image forming unit 103.

The image processing program executed by the image processing apparatus 200 may be stored in a recording medium connected to the I/O interface 205 and transferred from the recording medium to the HDD 211 or the main memory 204. For example, the recording medium storing information such as the image processing program is a computer-readable compact disc read only memory (CD-ROM), a flexible disk (FD), a compact disc recordable (CD-R), a digital versatile disk (DVD), or the like. The image processing program executed by the image processing apparatus 200 may be downloaded from a network such as the Internet connected via the I/O interface 205.

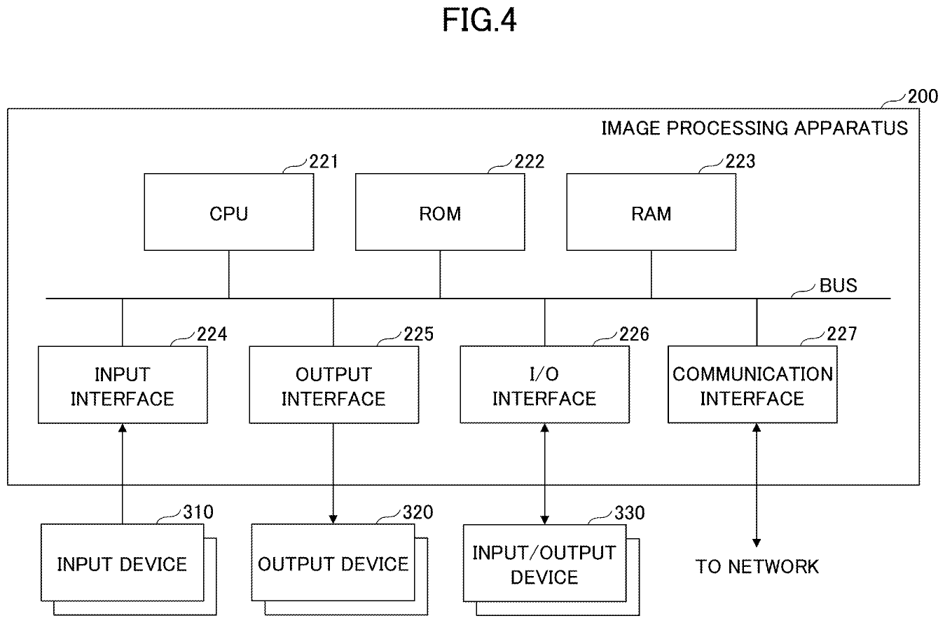

FIG. 4 is a block diagram illustrating an example of a hardware configuration of the image processing apparatus 200 in FIG. 1. The image processing apparatus 200 includes a CPU 221, a ROM 222, and a random access memory (RAM) 223. The image processing apparatus 200 includes an input interface 224, an output interface 225, an input/output (I/O) interface 226, and a communication interface 227. The CPU 221, the ROM 222, the RAM 223, and the I/O interface 226 correspond to the CPU 201, the ROM 202, the main memory 204, and the I/O interface 205 in FIG. 3, respectively.

For example, the CPU 221, the ROM 222, the RAM 223, the input interface 224, the output interface 225, the I/O interface 226, and the communication interface 227 are connected to each other via a bus BUS. The image processing apparatus 200 may be mounted on a computer apparatus such as a PC or a server having the hardware configuration illustrated in FIG. 4.

The CPU 221 executes various programs such as an operating system (OS) and applications. The ROM 222 holds a basic program, various parameters, and the like for enabling the CPU 221 to execute various programs. The RAM 223 stores various programs executed by the CPU 221 and data used in the programs. For example, the various programs may include an image processing program for performing image processing on a document image read by the image reader 101 in FIG. 1.

The input interface 224 is connected to the input device 310 such as an operation unit of the image reader 101 and the image forming apparatus 100. The output interface 225 is connected to the output device 320 of the image forming unit 103 and the like. The I/O device interface 226 is connected to an input/output device 330 such as an HDD 211 and a recording medium.

When various programs such as the image processing programs are stored in a recording medium, the programs are transferred from the recording medium to the RAM 223 or the like via the I/O interface 226. The communication interface 227 can connect the image processing apparatus 200 to a network or the like.

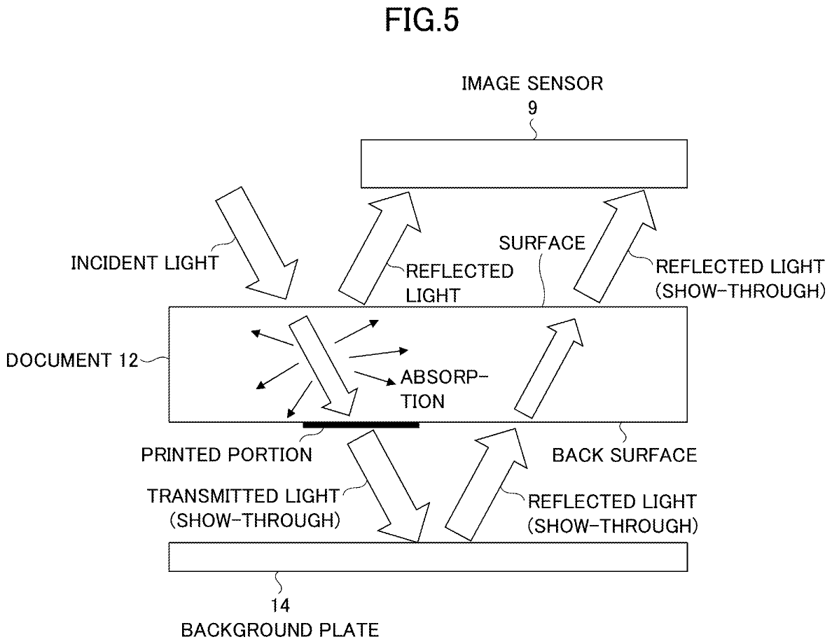

FIG. 5 is an explanatory diagram illustrating a state in which show-through occurs in the image reader 101 of FIG. 2. The show-through occurs when a part of the incident light for scanning passes through the document 12, then passes through a printed portion on the back surface of the document 12, is reflected by the background plate 14, and is input to the image sensor 9. At this point, since the reflected light from the surface of the document 12, which is the original read image, is also input to the image sensor 9, the image data obtained after scanning of the printed portion on the back surface, which causes show-through, has a characteristic that the color (hue, saturation) of the image data is close to the color (hue, saturation) of the surface (e.g., background image) of the document 12.

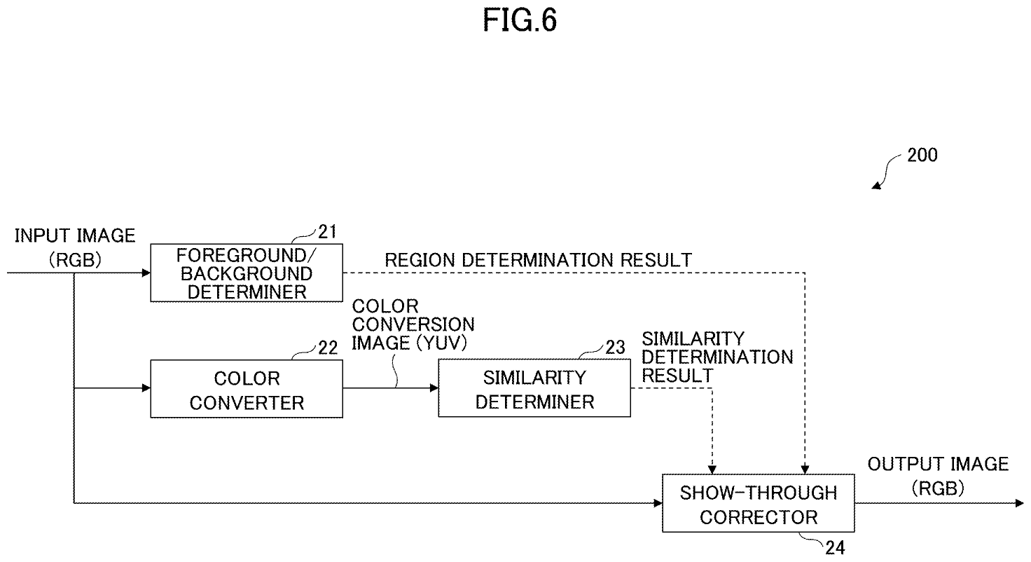

FIG. 6 is a functional block diagram illustrating an outline of a show-through correction process performed by the image processing apparatus 200 in FIG. 3. The dashed arrows illustrated in FIG. 6 indicate transmission of information indicating a determination result. Hereinafter, the image data and the pixel data may be referred to as an image and a pixel, respectively.

The image processing apparatus 200 that performs the show-through correction process includes a foreground/background determiner 21, a color converter 22, a similarity determiner 23, and a show-through corrector 24. For example, show-through can be eliminated by setting a show-through portion of the scanned image to the background color of an image on the surface of the document 12.

For example, the functions of the foreground/background determiner 21, the color converter 22, the similarity determiner 23, and the show-through corrector 24 are implemented by hardware such as the image processor 208 in FIG. 3. One or more functions of the foreground/background determiner 21, the color converter 22, the similarity determiner 23, and the show-through corrector 24 may be implemented by an image processing program executed by the CPU 201.

The foreground/background determiner 21 receives input image data of RGB generated by the image reader 101 that has read the document 12, and performs foreground/background determination processing of determining whether each of a plurality of regions included in the input image is a background region or a foreground region. The region to be determined is based on a pixel unit or a plurality of pixel units. In the following description, an example in which the background region or the foreground region is determined based on a pixel unit will be described.

A region determined as the background region is a show-through portion or a background portion of a document, and a region determined as the foreground region is a region not determined as the background region (i.e., an image region of a character, a picture, or the like). For example, the foreground/background determiner 21 calculates an edge amount (e.g., amount of change in luminance) using an image of an attention region to be determined as the foreground or the background and images of one or more regions around the attention region. The foreground/background determiner 21 determines that the attention region is a background (flat region) when the calculated edge amount is equal to or less than a threshold, and determines that the attention region is a foreground (character, picture, or the like) when the calculated edge amount is greater than the threshold. The foreground/background determiner 21 may discriminate between the background and the foreground by a method other than the above-described determination method according to the edge amount.

The foreground/background determiner 21 classifies a plurality of regions in an RGB input image that may contain show-through into the foreground region containing a foreground image and the background region containing a background image. Then, the foreground/background determiner 21 outputs a region determination result that has determined whether the attention region is the foreground region or the background region to the show-through corrector 24. For example, the region determination result is transmitted to the show-through corrector 24 as a 1-bit signal indicating whether the attention region is the background.

The color converter 22 converts the input image in an RGB color space into a YUV color space so as to divide a pixel included in each of the plurality of regions into a brightness component Y and color difference components U and V, and outputs the resolved components to the similarity determiner 23 as a color conversion image (YUV). The color converter 22 is an example of a component extractor that performs component extraction processing of extracting a brightness component and a color component of each of a plurality of regions included in the input image. For example, the conversion from the RGB color space to the YUV color space is performed by Expressions (1) to (3).

Y=0.299R+0.587G+0.114B (1)

U=−0.169R−0.331G+0.500B+128 (2)

V=0.500R−0.419G−0.081B+128 (3)

The color converter 22 may convert the RGB color space into another color space such as a YCbCr color space or a Lab color space as long as the RGB color space can be resolved into a brightness component (luminance) and color difference components (saturation, hue).

The similarity determiner 23 calculates the difference between the color components (U, V) of the attention region without including the brightness component (Y) and those of each of the plurality of reference regions located around the attention region in the color conversion image received from the color converter 22. The similarity determiner 23 performs similarity determination processing of determining whether the attention region and each of the plurality of reference regions are similar to each other based on the difference in color components, and outputs a similarity determination result to the show-through corrector 24.

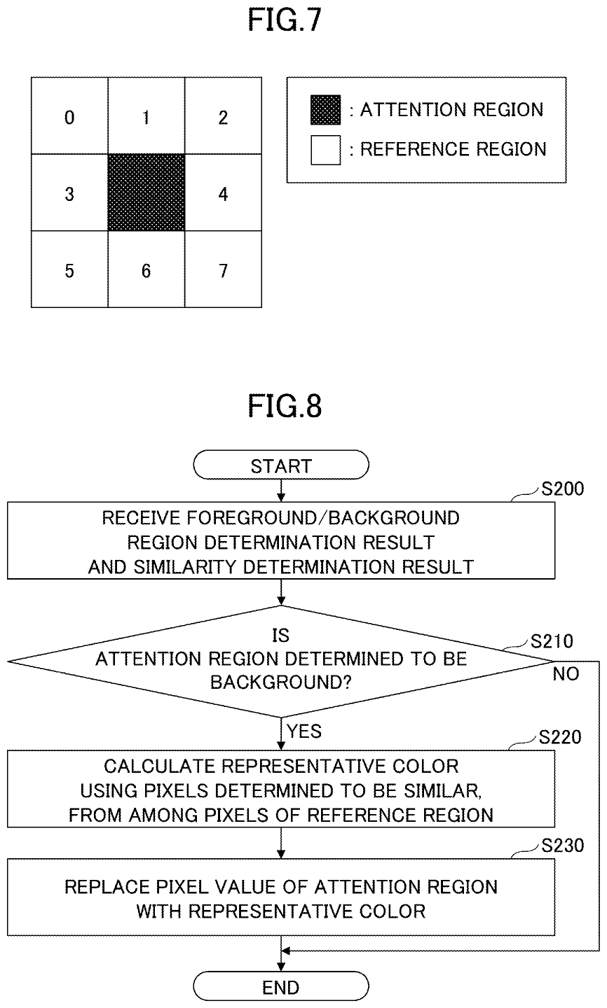

For example, when the foreground/background determiner 21 determines that the attention region is the background, a surrounding region determined to be similar to the attention region by the similarity determiner 23 is the background. The attention region is a region including a pixel that undergoes the show-through correction process, and each of the reference regions is a region including a pixel to be used for the show-through correction process. Examples of the attention region and the reference region are illustrated in FIG. 7.

The show-through corrector 24 receives the input image, the region determination result from the foreground/background determiner 21, and the similarity determination result from the similarity determiner 23, and performs a show-through correction process. When the foreground/background determiner 21 determines that the attention region is included in the background region, the show-through corrector 24 calculates a representative color using the reference regions determined to be similar to the attention region by the similarity determiner 23, and replaces the pixel value of the attention region with the calculated representative color.

The show-through corrector 24 sequentially shifts the attention region to a subsequent attention region to correct the shifted attention region using a corresponding reference region, generates a show-through removed image in which the show-through component of the input image is removed, and outputs the show-through removed image as an RGB output image. The representative color may be a pixel value of a region having the highest brightness in the reference region, or may be a value smoothed based on a tendency of a change in the pixel value of the reference region.

FIG. 7 is a diagram illustrating an example of an attention region and reference regions used in the show-through correction process of FIG. 6. For example, when the show-through correction process is performed using the reference regions directly adjacent to the attention region, the reference regions are eight pixels indicated by the numbers 0 to 7 around the attention region. The show-through corrector 24 performs the show-through correction process while sequentially shifting, by one pixel at a time, a pixel group including nine pixels centered on the attention region among the plurality of pixels included in the image.

For example, the show-through corrector 24 performs determination expressed by Expressions (4) and (5) below on the values of the color difference components U and V of each reference region, and determines that each of the reference regions satisfying both the conditions of Expressions (4) and (5) is similar to the attention region. Expression (4) is used to determine whether the difference (absolute value) between the value Utg of the color difference component U of the attention region tg and the value Uref of the color difference component U of the reference region ref is smaller than the threshold THu of the color difference component U. Expression (5) is used to determine whether the difference (absolute value) between the value Vtg of the color difference component V of the attention region tg and the value Vref of the color difference component V of the reference region ref is smaller than the threshold THv of the color difference component V. The thresholds THu and THv are configurable values of any values as parameters used for the show-through correction process.

|Utg−Uref|<THu (4)

|Vtg−Vref|<THv (5)

The show-through has a feature that the color of the show-through is similar to the color of the background of a show-through region, but is different in the brightness of the background. Therefore, the input image (RGB) is resolved into the brightness component and the color difference component, and a reference region having a color difference similar to that of the attention region is selected as the region used for the show-through correction process. This reduces the possibility of an abnormal image being generated due to performing the show-through correction process. Further, the show-through correction process is performed using a reference region in which the color difference components except the brightness component are similar to those of the attention region, which can delete a show-through portion appropriately. Here, the abnormal image is an image in which a pale character or the like on a color background is further faded or disappears by the show-through correction process.

When the reference region is used as a region whose color difference components and brightness component are similar to those of the attention region, a region that should be originally determined as the reference region may be determined to be dissimilar to the attention region. In this case, the show-through image remains as it is without any show-through correction process on the show-through image being performed.

FIG. 8 is a flowchart illustrating an example of the show-through correction process by the show-through corrector 24 of FIG. 6. That is, FIG. 8 illustrates an example of an image processing method performed by the image processing apparatus 200. The process illustrated in FIG. 8 is performed for each attention region while sequentially shifting the attention regions. When the function of the show-through corrector 24 is implemented by an image processing program, the process illustrated in FIG. 8 is performed by the image processing program.

First, in step S200, the show-through corrector 24 receives the foreground/background region determination result from the foreground/background determiner 21 and the similarity determination result from the similarity determiner 23. In step S200, the show-through corrector 24 may collectively receive the region determination results and the similarity determination results of all the regions on which the show-through correction process is performed.

Next, in step S210, the show-through corrector 24 determines whether or not the attention region is determined to be the background based on the region determination result. When the show-through corrector 24 determines that the attention region is the background, the process proceeds to step S220. When the attention region is not determined to be the background, that is, when the attention region is determined to be the foreground which is not the show-through, the show-through corrector 24 ends the processing on the current attention region because the show-through correction process is not necessary, and ends the process illustrated in FIG. 8 in order to perform the show-through correction process on a subsequent attention region.

In step S220, the show-through corrector 24 calculates a representative color using pixels of the reference regions determined to be similar to the attention region indicated the similarity by determination result among the plurality of pixels of the reference regions. For example, the show-through corrector 24 calculates the color (brightest color) of the brightest region among the reference regions determined to be similar to the attention region as the representative color. The representative color may be a mean value of colors of the regions determined to be similar to the attention region.

Next, in step S230, the show-through corrector 24 replaces the pixel value of the attention region with the representative color calculated in step S220, ends the show-through correction process illustrated in FIG. 8, and performs the show-through correction process on a subsequent attention region.

As described above, in the first embodiment, the input image (RGB) is resolved into the brightness component (Y) and the color difference components (U, V), and the reference region having a color difference similar to that of the attention region is selected as a region to be used for the show-through correction process. Accordingly, the correction process can be performed on the region with show-through while preventing the generation of an abnormal image that occurs when the show-through correction process is performed on the region without show-through. Further, the show-through correction process is performed using the reference region in which the color difference components except the brightness component are similar to those of the attention region, so that the show-through portion can be appropriately deleted.

### Second Embodiment

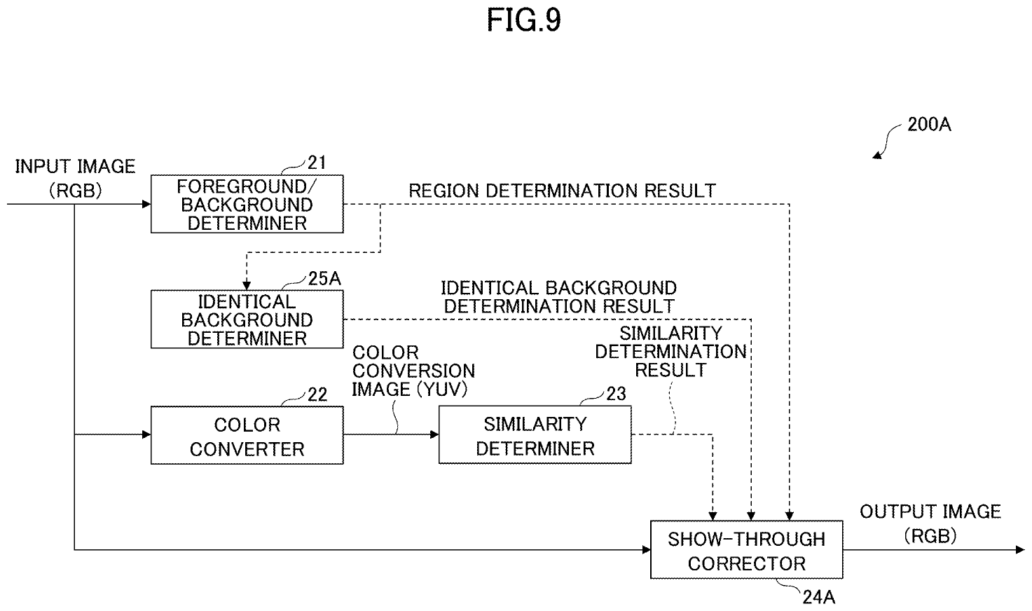

FIG. 9 is a functional block diagram illustrating an outline of a show-through correction process performed by an image processing apparatus according to a second embodiment of the present disclosure. The same components as those in FIGS. 1 to 3 and 6 are denoted by the same reference numerals, and detailed description thereof will be omitted. The dashed arrows illustrated in FIG. 9 indicate the transmission of information indicating the determination result. An image processing apparatus 200A that performs the show-through correction process illustrated in FIG. 9 is mounted on the image forming apparatus 100 instead of the image processing apparatus 200 in FIG. 1, for example. The functional configuration of the image processing apparatus 200A is the same as that in FIG. 3, and the hardware configuration of the image processing apparatus 200A is the same as that in FIG. 4.

The image processing apparatus 200A has the same configuration as the image processing apparatus 200 in FIG. 6 except that the image processing apparatus 200A includes, as functional blocks, a show-through corrector 24A instead of the show-through corrector 24 in FIG. 6 and additionally includes an identical background determiner 25A. The image processing apparatus 200A determines a region including one pixel as a unit, but may determine a region including a plurality of pixels as a unit.

For example, the functions of the foreground/background determiner 21, the color converter 22, the similarity determiner 23, the show-through corrector 24A, and the identical background determiner 25A are implemented by hardware such as the image processor 208 in FIG. 3. One or more functions of the foreground/background determiner 21, the color converter 22, the similarity determiner 23, the show-through corrector 24A, and the identical background determiner 25A may be implemented by the CPU 201 executing an image processing program.

The identical background determiner 25A receives a region determination result from the foreground/background determiner 21, and performs identical background determination processing of determining whether each of the plurality of reference regions included in the input image is an identical reference region having an identical background as the attention region. For example, the identical background determiner 25A determines, as the identical reference region, a reference region located closer to the attention region with respect to the reference regions determined as the foreground by the foreground/background determiner 21, among the reference regions determined as the background by the foreground/background determiner 21.

Then, the identical background determiner 25A outputs an identical background determination result indicating whether each reference region is an identical reference region to the show-through corrector 24A. For example, the identical background determination result is transmitted to the show-through corrector 24A as a 1-bit signal indicating whether or not each reference region is the identical background region.

The foreground/background determiner 21 determines whether each of a plurality of reference regions located around the attention region is a foreground or a background. Therefore, for example, when the reference region includes a boundary portion between the foreground and the background, a plurality of regions that interpose the region determined as the foreground may be determined as the background. The reference region having the region determined as the foreground interposed between the reference region and the attention region is located outside the boundary portion with respect to the attention region, and thus is preferably not included in regions subject to the show-through correction process.

The show-through corrector 24A receives the input image, the region determination result from the foreground/background determiner 21, the similarity determination result from the similarity determiner 23, and the identical background determination result from the identical background determiner 25A. When the foreground/background determiner 21 determines that the attention region is included in the background region, the show-through corrector 24A performs a show-through correction process on the attention region based on the similarity determination result by the similarity determiner 23 and the identical background determination result by the identical background determiner 25A.

For example, the show-through corrector 24A extracts a reference region located closer to the attention region than the reference region determined as the foreground, from among the identical reference regions determined as the identical background as the attention region by the identical background determiner 25A. The show-through corrector 24A calculates a representative color using a region determined to be similar to the attention region by the similarity determiner 23 among the extracted identical reference regions, and replaces the pixel value of the attention region with the calculated representative color. By performing the show-through correction process using only the region that does not interpose the reference region determined as the foreground with the attention region among the identical reference regions, the effect of the show-through correction can be enhanced and the possibility of generation of an abnormal image can be reduced.

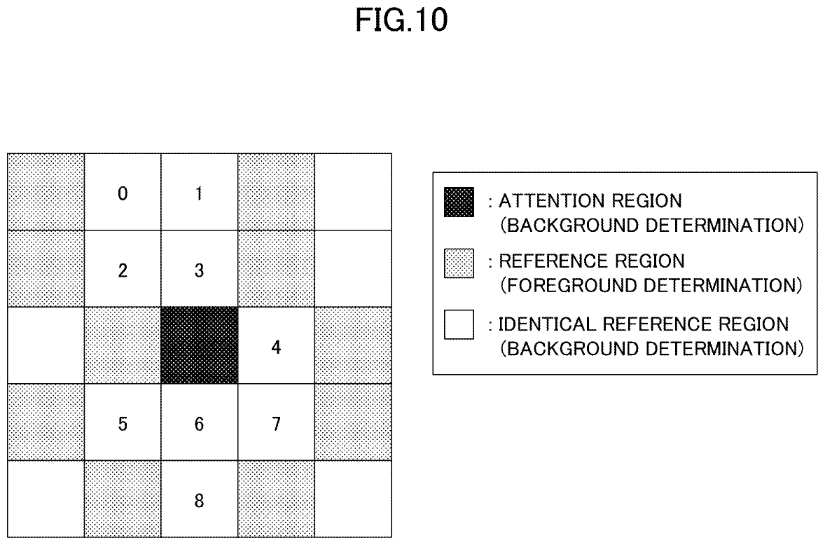

FIG. 10 is a diagram illustrating an example of the identical background determination result by the identical background determiner 25A in FIG. 9. FIG. 9 illustrates an example in which the reference regions are 24 pixels around the attention region. When the foreground/background determiner 21 determines that the attention region is the background, the identical background determiner 25A searches for the reference region determined as the foreground by the foreground/background determiner 21. The identical background determiner 25A extracts a reference region located between the attention region and the reference region determined as the foreground from the identical reference regions other than the reference region determined as the foreground. In the example illustrated in FIG. 10, the extracted reference regions are nine reference regions indicated by the numbers 0 to 8. Then, the show-through corrector 24A calculates a representative color using the extracted reference region, and replaces the pixel value of the attention region with the representative color.

Note that for a plurality of reference regions around the attention region, a plurality of patterns indicating positions of the foreground region and the background region respectively, and position information on a region used to calculate a representative color corresponding to each of the plurality of patterns may be prepared in advance. Then, when a pattern determined by the identical background determiner 25A matches any of a plurality of patterns prepared in advance, the show-through corrector 24A may calculate a representative color using a region indicated by the position information associated with the pattern as the identical reference region. In this case, since it is not necessary to determine whether or not each of the plurality of reference regions is a region for which a representative color is to be calculated, the processing of the show-through corrector 24 can be simplified, and for example, the hardware scale can be reduced.

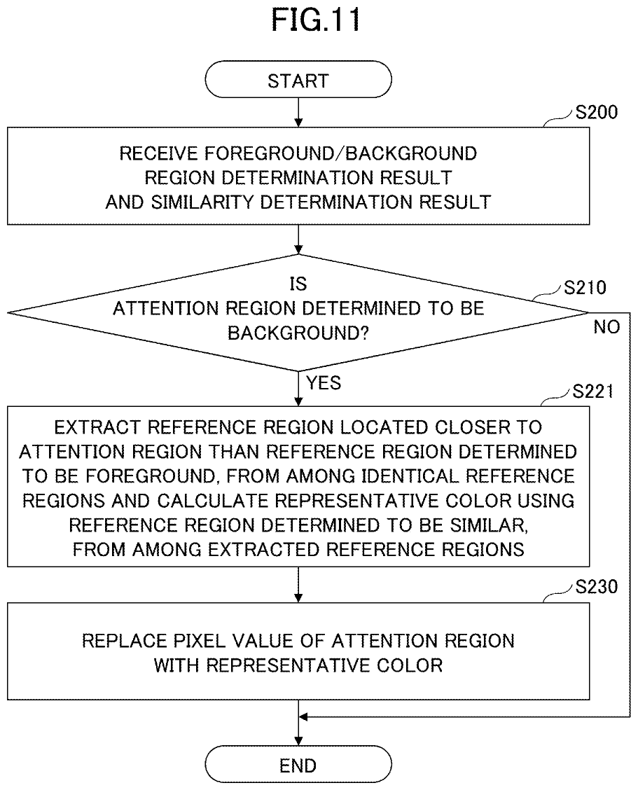

FIG. 11 is a flowchart illustrating an example of the show-through correction process by the show-through corrector 24A in FIG. 9. That is, FIG. 11 illustrates an example of an image processing method performed by the image processing apparatus 200A. The same processing as that in FIG. 8 is denoted by the same step number as that in FIG. 8, and the detailed description thereof will be omitted.

The process illustrated in FIG. 11 is performed for each attention region while sequentially shifting the attention regions, as in FIG. 8. When the function of the show-through corrector 24A is implemented by an image processing program, the process illustrated in FIG. 11 is performed by the image processing program.

The process illustrated in FIG. 11 is the same as the process illustrated in FIG. 8 except that step S220 is performed instead of step S221 in FIG. 8. When the attention region is determined to be the background in step S210, the show-through corrector 24A extracts, in step S221, a reference region located closer to the attention region than the reference region determined to be the foreground, from among the regions determined to be the identical reference regions by the identical background determiner 25A. Then, the show-through corrector 24A calculates a representative color using the reference region determined to be similar to the attention region by the similarity determiner 23 from among the extracted reference regions. Thereafter, in step S230, the show-through corrector 24 replaces the pixel value of the attention region with the representative color.

As described above, in the second embodiment, a representative color to replace the pixel value of the attention region is calculated using a reference region having a color difference similar to that of the attention region and located closer to the attention region than the reference region determined as the foreground, among the regions determined as the identical reference regions. This can further reduce the possibility of an abnormal image being generated by the show-through correction process and can enhance the effect of the show-through correction, as compared with the case where the representative color is calculated using all the reference regions determined as the background.

### Third Embodiment

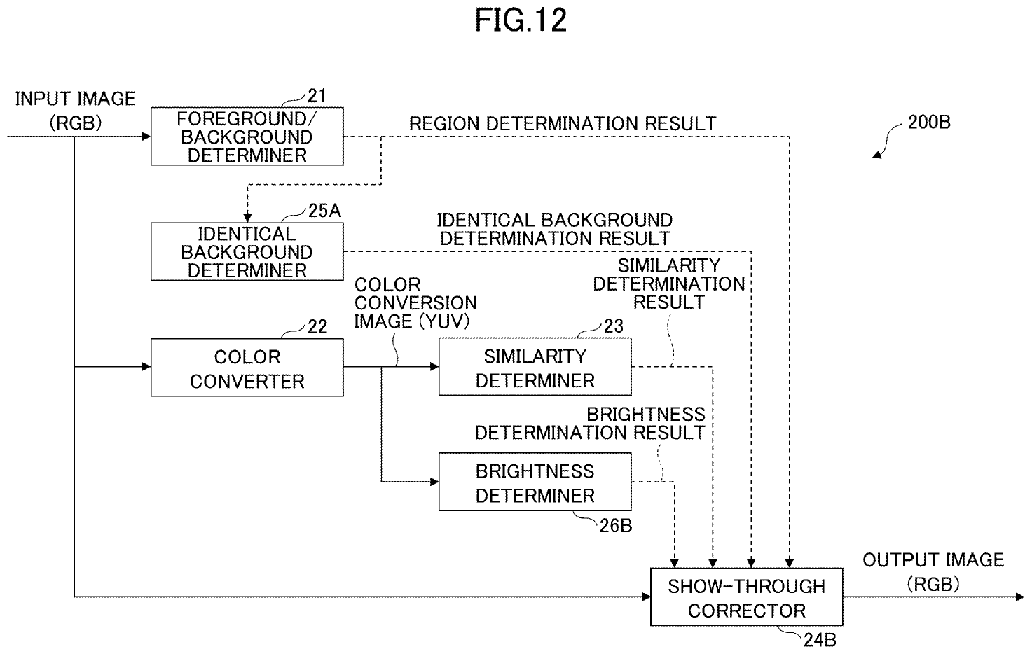

FIG. 12 is a functional block diagram illustrating an outline of a show-through correction process performed by an image processing apparatus according to a third embodiment of the present disclosure. The same components as those in FIGS. 1 to 3, 6, and 9 are denoted by the same reference numerals, and detailed description thereof will be omitted. The dashed arrows illustrated in FIG. 12 indicate the transmission of information indicating the determination result. An image processing apparatus 200B that performs the show-through correction process illustrated in FIG. 12 is mounted on the image forming apparatus 100 instead of the image processing apparatus 200 in FIG. 1, for example. A hardware configuration of the image processing apparatus 200B is the same as that in FIG. 3.

The image processing apparatus 200B has the same configuration as the image processing apparatus 200A in FIG. 9 except that the image processing apparatus 200B includes, as functional blocks, a show-through corrector 24B instead of the show-through corrector 24A in FIG. 9 and additionally includes a brightness determiner 26B. The image processing apparatus 200B determines a region including one pixel as a unit, but may determine a region including a plurality of pixels as a unit.

For example, the functions of the foreground/background determiner 21, the color converter 22, the similarity determiner 23, the show-through corrector 24, the identical background determiner 25A, and the brightness determiner 26B are implemented by hardware such as the image processor 208 in FIG. 3. One or more functions of the foreground/background determiner 21, the color converter 22, the similarity determiner 23, the show-through corrector 24, the identical background determiner 25A, and the brightness determiner 26B may be implemented by the CPU 201 executing an image processing program.

The brightness determiner 26B performs brightness determination processing of determining the magnitude of a brightness component (brightness Y) of the attention region using the YUV image converted by the color converter 22, and outputs a determination result to the show-through corrector 24B as a brightness determination result. For example, the brightness determiner 26B compares the brightness component of the attention region with a threshold, and determines that the attention region is a region with a pale color when the brightness component is greater than the threshold, and determines that the attention region is a region with a dark color when the brightness component is equal to or less than the threshold.

The show-through corrector 24B receives the input image, the region determination result from the foreground/background determiner 21, the similarity determination result from the similarity determiner 23, the identical background determination result from the identical background determiner 25A, and the brightness determination result from the brightness determiner 26B, and performs the show-through correction process.

When the brightness determination result of the attention region indicates a region with a pale color, the show-through corrector 24B performs the same show-through correction process as the show-through corrector 24A in FIG. 9. The show-through corrector 24B does not perform the show-through correction process when the brightness determination result of the attention region indicates a region with a dark color.

In the case of a document which is generally used, the show-through tends to have a pale color (i.e., the brightness is high) compared to characters and patterns written on the surface of the document. Therefore, by not performing the show-through correction process when the attention region has a dark color (i.e., the brightness is low), the possibility of generation of an abnormal image can be further reduced.

The image processing apparatus 200B may not include the identical background determiner 25A. In such a case, the show-through corrector 24B performs the show-through correction process without using the identical background determination result. That is, when the attention region determined as the background by the foreground/background determiner 21 indicates a pale region as a result of the brightness determination, the show-through corrector 24B calculates a representative color using the reference region determined as the background by the foreground/background determiner 21, and replaces the pixel value of the attention region with the representative color.

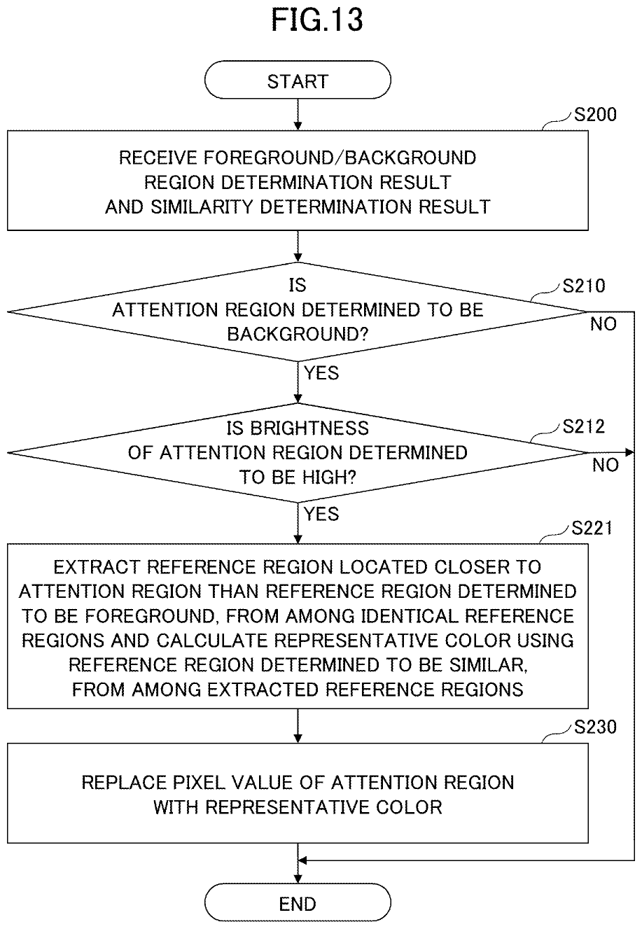

FIG. 13 is a flowchart illustrating an example of the show-through correction process performed by the show-through corrector 24B in FIG. 12. That is, FIG. 13 illustrates an example of an image processing method performed by the image processing apparatus 200B. The same processes as those in FIGS. 8 and 11 are denoted by the same step numbers as those in FIGS. 8 and 11, and detailed description thereof will be omitted.

The process illustrated in FIG. 13 is performed for each attention region while sequentially shifting the attention regions, as in FIG. 8. When the function of the show-through corrector 24B is implemented by an image processing program, the process illustrated in FIG. 13 is performed by the image processing program.

The process illustrated in FIG. 13 is the same as the process illustrated in FIG. 11 except that a step S212 is inserted between the step S210 and the step S221 in FIG. 11. When the attention region is determined to be the background in step S210, the show-through corrector 24B determines whether the brightness of the attention region is determined to be high (the color is pale) based on the brightness determination result in step S212.

When the brightness of the attention region is determined to be high, the show-through corrector 24B shifts the processing to step S221. When the brightness of the attention region is not determined to be high, that is, when the brightness of the attention region is low, the show-through corrector 24B ends the processing of the current attention region because the show-through correction process is not necessary, and ends the process illustrated in FIG. 13 in order to perform the show-through correction process on a subsequent attention region. When the image processing apparatus 200B does not include the identical background determiner 25A, step S221 in FIG. 8 is performed instead of the process in step S220.

As described above, in the third embodiment, embodiments, the as in the first and second representative color to replace the pixel value of the attention region is calculated using the reference region having a color difference similar to that of the attention region, thereby reducing the possibility of an abnormal image being generated by the show-through correction process.

Furthermore, in the third embodiment, when the color of the attention region is determined to be pale, the show-through correction process is performed using only the identical reference region among the reference regions determined as the background, and when the color of the attention region is determined to be dark, the show-through correction process is not performed. This can prevent the show-through correction process from being performed when the attention region indicates a region with a dark color in the image, which can further reduce the possibility of generation of an abnormal image.

### Fourth Embodiment

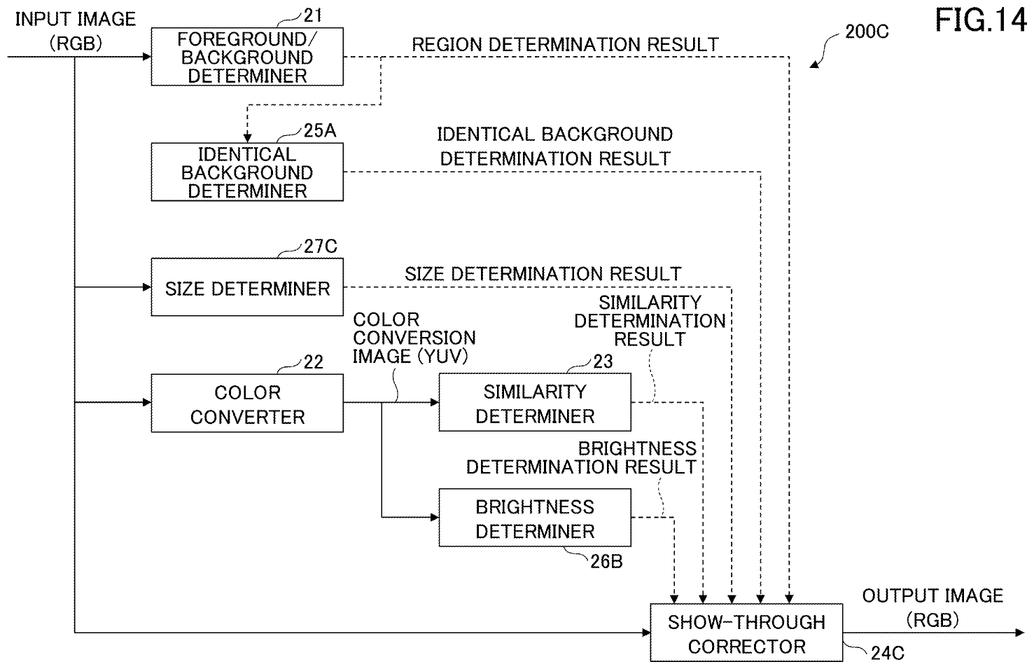

FIG. 14 is a functional block diagram illustrating an outline of a show-through correction process performed by an image processing apparatus according to a fourth embodiment of the present disclosure. The same components as those in FIGS. 1 to 3, 6, 9, and 12 are denoted by the same reference numerals, and detailed description thereof will be omitted. The dashed arrows illustrated in FIG. 14 indicate the transmission of information indicating the determination result. An image processing apparatus 200C that performs the show-through correction process illustrated in FIG. 14 is mounted on the image forming apparatus 100 instead of the image processing apparatus 200 in FIG. 1, for example. A hardware configuration of the image processing apparatus 200C is the same as that in FIG. 3.

The image processing apparatus 200C has the same configuration as the image processing apparatus 200B in FIG. 12 except that the image processing apparatus 200C includes, as functional blocks, a show-through corrector 24C instead of the show-through corrector 24B in FIG. 12 and additionally includes a size determiner 27C. The image processing apparatus 200C determines a region including one pixel as a unit, but may determine a region including a plurality of pixels as a unit.

For example, the functions of the foreground/background determiner 21, the color converter 22, the similarity determiner 23, the show-through corrector 24C, the identical background determiner 25A, the brightness determiner 26B, and the size determiner 27C are implemented by hardware such as the image processor 208 in FIG. 3. One or more functions of the foreground/background determiner 21, the color converter 22, the similarity determiner 23, the show-through corrector 24C, the identical background determiner 25A, the brightness determiner 26B, and the size determiner 27C may be implemented by the CPU 201 executing an image processing program.

The size determiner 27C performs size determination processing of searching for a reference region similar to the attention region determined as the background, and determining a size of a set of reference regions that are similar to the attention region as a size of show-through. Then, the size determiner 27C outputs the determined size of the show-through to the show-through corrector 24C as a size determination result.

For example, the size determiner 27C calculates a Euclidean distance between the attention region and each of the reference regions similar to the attention region, and sets the maximum value of the Euclidean distance as the size of the show-through. For example, the size determiner 27C performs the similarity determination with the attention region using RGB. The size determiner 27C performs the size determination processing regardless of whether the attention region is actually show-through.

The show-through corrector 24C performs a show-through correction process on the attention region using pixels in the reference regions. For example, when the show-through occurs beyond a range of the reference regions, a region beyond the range of the reference regions will not be used, and therefore it appears difficult to completely correct the show-through, thereby generating an abnormal image.

Therefore, when the size of the show-through exceeds the size of the range of the reference regions, it is preferable not to perform the show-through correction process. Therefore, the show-through corrector 24C compares the size of the show-through indicated by the size determination result output from the size determiner 27C with a predetermined threshold corresponding to the size of the range of the reference regions. The show-through corrector 24C performs the same show-through correction process as the show-through corrector 24B in FIG. 12.

The image processing apparatus 200C may not include the identical background determiner 25A. In this case, the show-through corrector 24C performs the show-through correction process without using the identical background determination result. The image processing apparatus 200C may not include the brightness determiner 26B. In this case, the show-through corrector 24C performs the show-through correction process without using the brightness determination result. Further, the image processing apparatus 200C may not include both the identical background determiner 25A and the brightness determiner 26B.

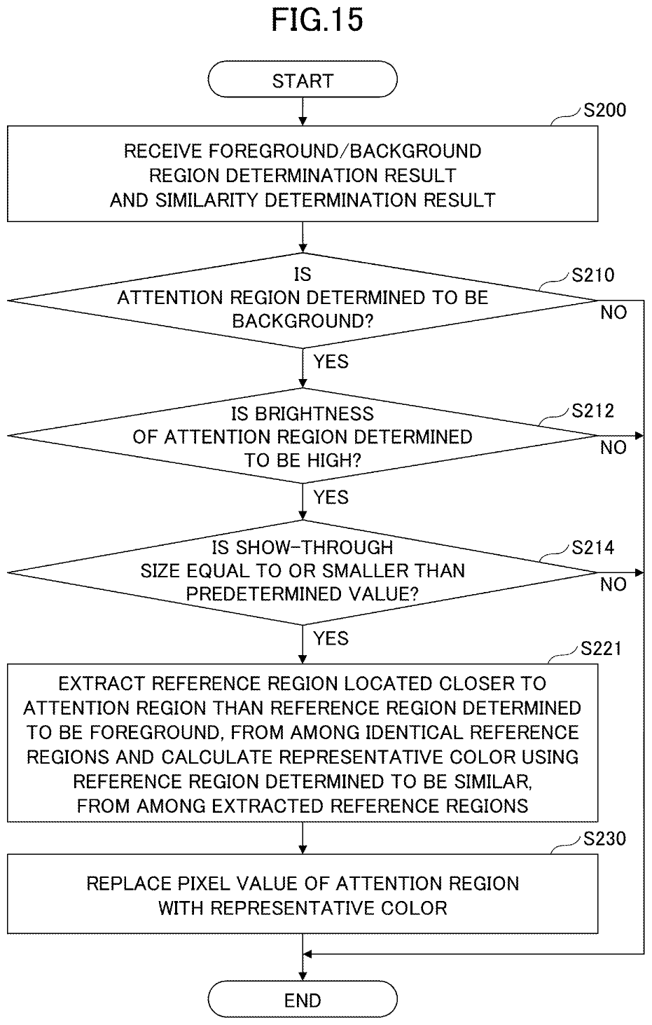

FIG. 15 is a flowchart illustrating an example of the show-through correction process by the show-through corrector 24C in FIG. 14. That is, FIG. 15 illustrates an example of an image processing method performed by the image processing apparatus 200C. The same processes as those in FIGS. 8, 11, and 13 are denoted by the same step numbers as those in FIGS. 8, 11, and 13, and detailed description thereof will be omitted.

The process illustrated in FIG. 15 is performed for each attention region while sequentially shifting the attention regions, as in FIG. 8. When the function of the show-through corrector 24C is implemented by an image processing program, the process illustrated in FIG. 15 is performed by the image processing program.

The process illustrated in FIG. 15 is the same as the process illustrated in FIG. 13 except that a step S214 is inserted between the step S212 and the step S221 in FIG. 13.

When the brightness of the attention region is determined to be high (the color is pale) in step S212, the show-through corrector 24C compares the size of show-through indicated by the size determination result with the threshold in step S214. Here, the threshold corresponds to the size of the range of the reference regions. When the size of show-through is equal to or smaller than a predetermined threshold, the show-through corrector 24C shifts the processing to step S221 and performs the show-through correction process. On the other hand, when the size of show-through exceeds the predetermined threshold, the show-through r 24C determines s that it appears difficult to completely correct the show-through, ends the processing on the current attention region, and ends the process illustrated in FIG. 15 in order to perform the show-through correction process on a subsequent attention region.

When the image processing apparatus 200C does not include the identical background determiner 25A, step S220 in FIG. 8 is performed instead of the process in step S221. In addition, when the image processing apparatus 200C does not include the brightness determiner 26B, the processing of step S212 is omitted. Further, when the image processing apparatus 200C does not include both the identical background determiner 25A and the brightness determiner 26B, the processing of step S220 of FIG. 8 is performed instead of the processing of step S221, and the processing of step S212 is omitted.

As described above, in the fourth embodiment, as in the first and second embodiments, the representative color to replace the pixel value of the attention region is calculated using the reference region having a color difference similar to that of the attention region, thereby reducing the possibility of an abnormal image being generated by the show-through correction process. Further, as in the third embodiment, when the color of the attention region is determined to be dark, the show-through correction process will not be performed, and thus it is possible to reduce the possibility of generation of an abnormal image.

Furthermore, in the fourth embodiment, when the size of show-through output from the size determiner 27C exceeds the threshold, it appears difficult to completely correct the show-through, and thus the show-through correction process is not performed. Accordingly, when the show-through occurs beyond the range of the reference regions, it is possible to prevent the show-through correction process from being performed using only the reference regions within the range of the reference regions to prevent the generation of an abnormal image.

### Fifth Embodiment

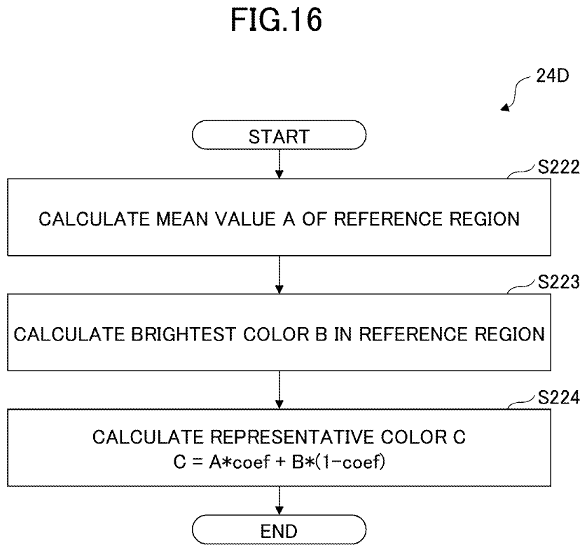

FIG. 16 is a flowchart illustrating an example of processing of calculating the representative color in the show-through correction process performed by an image processing apparatus according to a fifth embodiment of the present disclosure. A flowchart illustrated in FIG. 16 is executed in the processing of step S220 in FIG. 8 or step S221 in FIG. 11, FIG. 13, or FIG. 15. That is, the flowchart illustrated in FIG. 16 is performed by any one of the show-through corrector 24 in FIG. 6, the show-through corrector 24A in FIG. 9, the show-through corrector 24B in FIG. 12, and the show-through corrector 24C in FIG. 14.

In the following description, the flowchart illustrated in FIG. 16 is assumed to be performed by a show-through corrector 24D. The image processing apparatus including the show-through corrector 24D is mounted on the image forming apparatus 100 instead of the image processing apparatus 200 in FIG. 1, for example. A hardware configuration of the image processing apparatus including the show-through corrector 24D is the same as that in FIG. 3.

In each of the above-described embodiments, when the representative color is a true background color, the show-through correction process can be correctly performed provided that the attention region is a show-through region. On the other hand, when the attention region is not a show-through region, there is a possibility that erroneous show-through correction process is performed and an abnormal image is obtained. For example, in a region where the gradation changes in a stepwise manner, a region with a pale color may encroach a region with a dark color, resulting in an abnormal image.

In order to prevent the above described adverse effect, a method of calculating a plurality of candidates for the representative color and selecting the most appropriate one candidate from the calculated plurality of candidates, or a method of combining a plurality of representative colors is considered. FIG. 16 illustrates an example of combining two types of representative color candidates at a ratio corresponding to a coefficient coef (0 to 1).

First, in step S222, the show-through corrector 24D calculates a mean value A of the reference regions used for calculating the representative color in the range of the reference regions. Next, in step S223, the show-through corrector 24D calculates a brightest color B, which is the brightest color in the reference regions used for calculating the representative color in the range of the reference regions. The brightest color B may be calculated using RGB data or may be calculated using the luminance Y of YUV. The brightest color B is an example of a first correction color.

The show-through corrector 24 includes a correction color calculator that calculates the brightest color B and a correction color calculator that calculates the mean value A of the reference regions. The correction color calculator that calculates the brightest color B is an example of a first correction color calculator. The correction color calculator that calculates the mean value A is an example of a second correction color calculator that calculates a color darker than the brightest color B.

Next, in step S224, step the show-through corrector 24D calculates a representative color C to replace the pixel value of the attention region by combining the mean value A and the brightest color B at a predetermined ratio based on the coefficient coef. For example, the representative color C is represented as RGB data. Then, after step S224, the show-through corrector 24D performs the show-through correction process by replacing the pixel value of the attention region with the representative color C. Thus, for example, even when the brightest color B calculated in step S223 is largely different from the true background color, the brightest color B is neutralized to some extent by the mean value A calculated in step S222, and the possibility of an abnormal image can be reduced.

Since the show-through has a characteristic that the show-through is read darker than the true background color, the brightest color B calculated in step S223 is a first candidate for the true background color. The mean value A calculated in step S222 is a second candidate for a case where the brightest color B is not a true background color or for a case where the attention region is not a show-through. By using the coefficient coef, it is possible to appropriately adjust the correction intensity, which is a ratio of the combination, even when the representative color C is calculated using a plurality of types of color information such as the mean value A and the brightest color B.

In step S222, the mean value A of the reference regions used for calculating the representative color within the range of the reference regions is calculated, but a calculation method other than that for the mean value A may be used as long as a value darker than the brightest color calculated in step S223 is calculated.

Further, the show-through corrector 24D may create a histogram of the brightness of the reference regions used for calculating the representative color in step S223, and calculate an alternative color to the brightest color B using the most frequent brightness in the distribution that is equal to or higher than a predetermined brightness.

As described above, the fifth embodiment can also provide the same effects as those of the first to fourth embodiments. Furthermore, in the fifth embodiment, a plurality of candidates for the representative color are combined at a predetermined ratio to calculate the representative color C to replace the pixel value of the attention region, and thus it is possible to reduce the possibility of an abnormal image compared to a case where one type of the representative color is used.

In the fifth embodiment, an example is described in which two types of representative colors (the mean value A and the brightest color B) are combined at a predetermined ratio to calculate the representative color C to replace the pixel value of the attention region, but three or more types of representative colors may be combined at a predetermined ratio to calculate the representative color C to replace the pixel value of the attention region.

Aspects of the present disclosure are as follows, for example.

### <Aspect 1>

An image processing apparatus comprising:
a foreground/background determiner configured to classify a plurality of regions in an input image into a foreground region containing a foreground image and a background region containing a background image;
a component extractor configured to extract a brightness component and a color component of each of the plurality of regions;
a similarity determiner configured to determine whether, from among the plurality of regions, an attention region and each of a plurality of reference regions located around the attention region are similar, based on a difference between a color component of the attention region and a color component of a corresponding one of the plurality of reference
regions; and a show-through corrector configured to correct, in response to the attention region being determined to be included in the background region, the attention region using a reference region determined to be similar to the attention region, wherein a show-through removed image, from which a show-through component of the input image is removed, is generated by sequentially shifting the attention region to a subsequent attention region to correct the shifted attention region.

### <Aspect 2>

The image processing apparatus according to aspect 1, further comprising:
an identical background determiner configured to determine whether each of the reference regions and the attention region have an identical background,
wherein the show-through corrector corrects, in response to the attention region being determined to be included in the background region, the attention region using a reference region determined to have the identical background as the attention region and located closer to the attention region than a reference region determined not to have the identical background as the attention region, from among the reference regions determined to be similar to the attention region.

### <Aspect 3>

The image processing apparatus according to aspect 1 or 2, further comprising:
a brightness determiner configured to determine brightness of the attention region based on the brightness component extracted by the component extractor,
wherein the show-through corrector does not correct the attention region, in response to the brightness of the attention region being determined to be lower than a predetermined brightness.

### <Aspect 4>

The image processing apparatus according to any one of aspects 1 to 3, further comprising:
a size determiner configured to determine a size of regions each having a color similar to the attention region determined as the background, from among the plurality of regions,
wherein the show-through corrector does not correct the attention region, in response to the determined size exceeding the size of the plurality of reference regions.

### <Aspect 5>

The image processing apparatus according to any one of aspects 1 to 4, further comprising:
a plurality of correction color calculators configured to calculate a plurality of correction colors used for correcting the attention region using the plurality of reference regions,
wherein the show-through corrector combines the calculated plurality of correction colors at a predetermined ratio and corrects the attention region using a correction color obtained by the combination.

### <Aspect 6>

The image processing apparatus according to claim 5, wherein the plurality of correction color calculators include
a first correction color calculator configured to calculate a brightest color as a first correction color, from among colors of the plurality of reference regions; and
a second correction color calculator configured to calculate a color darker than the first correction color as a second correction color, using the colors of the plurality of reference regions.

### <Aspect 7>

An image forming apparatus comprising:
an image reader configured to read an image included in a document and generate an input image;
the image processing apparatus according to any one of aspects 1 to 6, the image processing apparatus being configured to process the input image and generate the show-through removed image; and
an image forming unit configured to form the image processed by the image processing apparatus.

### <Aspect 8>

An image processing method comprising:
classifying a plurality of regions in an input image into a foreground region containing a foreground image and a background region containing a background image;
extracting a brightness component and a color component of each of the plurality of regions;
determining whether, from among the plurality of regions, an attention region and each of a plurality of reference regions located around the attention region are similar, based on a difference between a color component of the attention region and a color component of a corresponding one of the plurality of reference regions;
correcting, in response to the attention region being determined to be included in the background region, the attention region using a reference region determined to be similar to the attention region; and
generating a show-through removed image, from which a show-through component of the input image is removed, by sequentially shifting the attention region to a subsequent attention region to correct the shifted attention region.

### <Aspect 9>

A non-transitory computer-readable recording medium storing an image processing program, which, when executed by an image processing apparatus, causes the image processing apparatus to perform a process comprising:
classifying a plurality of regions in an input image into a foreground region containing a foreground image and a background region containing a background image;
extracting a brightness component and a color component of each of the plurality of regions;
determining whether, from among the plurality of regions, an attention region and each of a plurality of reference regions located around the attention region are similar, based on a difference between a color component of the attention region and a color component of a corresponding one of the plurality of reference regions;
correcting, in response to the attention region being determined to be included in the background region, the attention region using a reference region determined to be similar to the attention region; and
generating a show-through removed image, from which a show-through component of the input image is removed, by sequentially shifting the attention region to a subsequent attention region to correct the shifted attention region.

The present disclosure has been described above based on the embodiments, but the present disclosure is not limited to the requirements described in the above embodiments. These points can be changed without departing from the spirit of the present disclosure, and can be appropriately determined according to the application form.

What is claimed is:

1. An image processing apparatus comprising circuitry configured to
classify a plurality of regions in an input image into a foreground region containing a foreground image and a background region containing a background image;
extract a brightness component and a color component of each of the plurality of regions;
determine whether, from among the plurality of regions, an attention region and each of a plurality of reference regions located around the attention region are similar based on a difference between a color component of the attention region and a color component of a corresponding one of the plurality of reference regions;
correct, in response to the attention region being determined to be included in the background region, the attention region using a reference region determined to be similar to the attention region; and
generate a show-through removed image, from which a show-through component of the input image is removed, by sequentially shifting the attention region to a subsequent attention region to correct the shifted attention region.

2. The image processing apparatus according to claim 1, wherein the circuitry is further configured to
determine whether each of the reference regions and the attention region have an identical background,
wherein the circuitry corrects, in response to the attention region being determined to be included in the background region, the attention region using a reference region determined to have the identical background as the attention region and located closer to the attention region than a reference region determined not to have the identical background as the attention region, from among the reference regions determined to be similar to the attention region.

3. The image processing apparatus according to claim 1, wherein the circuitry is further configured to
determine brightness of the attention region based on the extracted brightness component,
wherein the circuitry does not correct the attention region, in response to the brightness of the attention region being determined to be lower than a predetermined brightness.

4. The image processing apparatus according to claim 1, wherein the circuitry is further configured to
determine a size of regions each having a color similar to the attention region determined as the background, from among the plurality of regions,
wherein the circuitry does not correct the attention region, in response to the determined size exceeding the size of the plurality of reference regions.

5. The image processing apparatus according to claim 1, wherein the circuitry is further configured to
calculate a plurality of correction colors used for correcting the attention region using the plurality of reference regions,
wherein the circuitry combines the calculated plurality of correction colors at a predetermined ratio and corrects the attention region using a correction color obtained by the combination.

6. The image processing apparatus according to claim 5, wherein the circuitry is further configured to
calculate a brightest color as a first correction color, from among colors of the plurality of reference regions; and
calculate a color darker than the first correction color as a second correction color, using the colors of the plurality of reference regions.

7. An image forming apparatus comprising:
the image processing apparatus according to claim 1; and
circuitry configured to
read an image included in a document and generate the input image, the generated input image being processed by the image processing apparatus to generate the show-through removed image; and
form the image processed by the image processing apparatus.

8. An image processing method comprising:
classifying a plurality of regions in an input image into a foreground region containing a foreground image and a background region containing a background image;
extracting a brightness component and a color component of each of the plurality of regions;
determining whether, from among the plurality of regions, an attention region and each of a plurality of reference regions located around the attention region are similar, based on a difference between a color component of the attention region and a color component of a corresponding one of the plurality of reference regions;
correcting, in response to the attention region being determined to be included in the background region, the attention region using a reference region determined to be similar to the attention region; and
generating a show-through removed image, from which a show-through component of the input image is removed, by sequentially shifting the attention region to a subsequent attention region to correct the shifted attention region.

9. A non-transitory computer-readable recording medium storing an image processing program, which, when executed by an image processing apparatus, causes the image processing apparatus to perform a process comprising:
classifying a plurality of regions in an input image into a foreground region containing a foreground image and a background region containing a background image;
extracting a brightness component and a color component of each of the plurality of regions;
determining whether, from among the plurality of regions, an attention region and each of a plurality of reference regions located around the attention region are similar, based on a difference between a color component of the attention region and a color component of a corresponding one of the plurality of reference regions;
correcting, in response to the attention region being determined to be included in the background region, the attention region using a reference region determined to be similar to the attention region; and
generating a show-through removed image, from which a show-through component of the input image is removed, by sequentially shifting the attention region to a subsequent attention region to correct the shifted attention region.

10. The image processing method according to claim 8, further comprising:
determining whether each of the reference regions and the attention region have an identical background; and
wherein the correcting includes correcting, in response to the attention region being determined to be included in the background region, the attention region using a reference region that is determined to have the identical background as the attention region and that is located closer to the attention region than a reference region that is determined not to have the identical background as the attention region, from among the reference regions determined to be similar to the attention region.

11. The image processing method according to claim 8, further comprising:
determining brightness of the attention region based on the extracted brightness component; and
without correcting the attention region, in response to the brightness of the attention region being determined to be lower than a predetermined brightness.

12. The image processing method according to claim 8, further comprising:
determining a size of regions each having a color similar to the attention region determined as the background, from among the plurality of regions; and
without correcting the attention region, in response to the determined size exceeding the size of the plurality of reference regions.

13. The image processing method according to claim 8, further comprising:
calculating a plurality of correction colors used for correcting the attention region using the plurality of reference regions; and
combining the calculated plurality of correction colors at a predetermined ratio and correcting the attention region using a correction color obtained by the combination.

14. The image processing method according to claim 13, further comprising:
calculating a brightest color as a first correction color, from among colors of the plurality of reference regions; and
calculating a color darker than the first correction color as a second correction color, using the colors of the plurality of reference regions.
